(19) United States
(12) Patent Application Publication
(10) Pub. No.: US 2009/0184515 A1
(43) Pub. Date: Jul. 23, 2009

(54) EXPANSION JOINT ARRANGEMENT

(75) Inventor: Philip B. Argersinger, West Monroe, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: FHC Properties, LLC, East Syracuse, NY (US)

(21) Appl. No.: 12/017,490

(22) Filed: Jan. 22, 2008

(51) Int. Cl. F16L 51/02

(52) U.S. Cl. 285/229

(57) ABSTRACT

Provision is made to limit the degree of expansion of an expansion joint having a flexible body interposed between a pair of axially spaced flanges. The flanges or radial extensions thereof are interconnected by two or more circumferentially spaced cables, with the cables being unitary in form but having a pair of parallel strands, with the two ends of the cable being interconnected such that the two stands limit the expansion of the joint. Compression of the assembly is limited by way of a sleeve disposed on one strand and adapted to have its ends engage the inner surfaces of the flanges or radial extensions thereof upon reaching the limit of intended compression.

### TECHNICAL FIELD

This invention relates generally to flexible expansion joints and, more particularly, to a method and apparatus for limiting the axial extension and compression thereof.

### BACKGROUND OF THE INVENTION

Expansion joints are commonly installed in piping systems such as those used in the chemical processing industry, and in the air conditioning, heating, plumbing, refrigerating and ventilating fields. The purposes of such a joint are to provide flexibility for accommodating expansion and contraction due to pressure and temperature variations, and for damping vibrations to thereby reduce noise. In the absence of such an expansion joint in a piping or ducting system, the vibrations and the pressure and thermal changes can produce stress on the system at fixed points such as at vessels and rotating equipment, as well as in the piping or ductwork system itself.

Typically, an expansion joint includes a fluid conducting flexible body member secured between a pair of spaced flanges, with the combination then being interposed within a length of pipe or duct. The flexible body member may be in the form of a metal bellows, a Teflon bellows or an elastomeric spherical arch.

Recognizing that under certain conditions, the assembly can be expanded or contracted beyond the allowable limits of safe operation, provision has been made to axially restrain such motion. This has customarily been accomplished by a pair of limit rods that are axially mounted on opposite sides of the joint and connected at their opposite ends to the flanges or to gusset plates attached to and extending radially outwardly from the coupling flanges. Overextension was prevented by fasteners attached to the limit rods on the axially outer sides of the flanges. Compression of the unit was limited by fasteners located on the axially inner sides of the flanges or by way of a pipe sleeve disposed over each of the tie rods.

Because of the rigidity of the tie rods, and the relative inflexibility of the combination during installation within a system, some expansion joints are now being assembled without tie rods but with a flexible link, such as a cable, interconnecting the spaced flanges. One such arrangement is shown in U.S. Pat. No. 5,273,321. While such an arrangement provides for limited expansion of the joint, it does not prevent the joint from being compressed beyond the allowable limits. Further the need to secure the cables to the flanges complicates the process.

What is needed is an expansion joint that is flexible for installation purposes but which is limited in its axial movement in operational conditions of both expansion and contraction.

### DISCLOSURE OF THE INVENTION

Briefly, in accordance with one aspect of the invention, a cable is secured between two gussets by simply extending the cable through one opening in each gusset and then back through another opening therein, with the ends being secured together by a single crimping device.

In accordance with another aspect of the invention, compression of the assembly is limited by a sleeve which is disposed over one strand of the cable, with the other strand being outside of the sleeve to facilitate the crimping process.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is an elevational view of a typical piping installation with expansion joints in accordance with the prior art.

FIG. 2 is a front view, partially in cross section, of an expansion joint in accordance with the prior art.

FIG. 3 is a perspective view of one embodiment of the present invention.

FIG. 4 is an alternative embodiment of the invention.

### DETAILED DESCRIPTION OF THE INVENTION

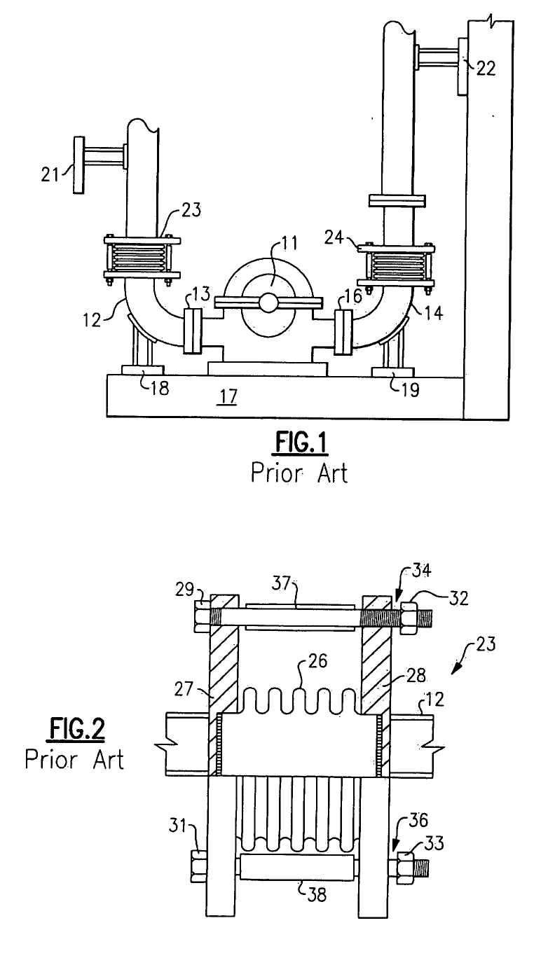

A typical fluid flow pumping and piping arrangement is shown in FIG. 1 which includes a pump 11 fluidly connected to an intake pipe 12 by a flange connection 13 and to a discharge pipe 14 by way of a flange connection 16. The pump 11, although securely fastened to the foundation 17 will tend to transmit some motion to the intake pipe 12 and discharge pipe 14 by vibrations and the like. Support for the piping is provided by way of anchor structures 18 and 19 which are supported by the foundation 17 and by anchor structures 21 and 22 which are securely fastened to vertical support structures within the building.

In addition to the movement as caused by vibrations as discussed hereinabove, thermal and pressure differences will tend to cause the piping system to expand or contract. That is, as the temperature and/or pressure of the fluid being pumped through the system rises, the piping system will tend to expand, and as they are lowered, the piping system will contract. To accommodate that expansion and contraction, a pair of expansion joints 23 and 24 are installed within the piping system, on either side of the pump 11. The structure of the expansion joints 23 and 24 is set forth in more detail in FIG. 2.

Fluidly interconnected between sections of pipe 12 is a fluid conducting flexible body member 26 with appropriate end fittings to match the adjoining pipe fittings. The particular member as shown is a so called bellows design which is formed as a thin walled tubing to form a corrugated cylinder with a plurality of convolutions as shown. Such a member is commonly made from metal (e.g. stainless steel) or Teflon, for example.

The present invention is also applicable to other types of expansion joints. For example, one type of flexible joint commonly used with plastic piping systems is not bellows shaped as shown but rather is formed of a molded spherical flowing arch that is made from an elastomeric material. Although different in structure, these expansion joints also require some type of structure to limit the expansion and contraction of the joint.

The flexible body member 26 is disposed between and connected to a pair of axially spaced flanges 27 and 28 with the interconnection between the flexible body member 26 and the flanges 28 being such that, as the body member 26 expands or contracts, the flanges 27 and 28 are accordingly caused to move toward or away from each other.

Disposed near the radially outer edges of the flanges 27 and 28 are a pair of radially, circumferentially spaced axially disposed tie rod pins 29 and 31 and their associated nuts 32 and 33. The tie rods pins 29 and 31 pass through holes formed in the respective flanges 27 and 28 and the respective nuts 32 and 33 are so positioned on the respective pins 29 and 31, such that clearance spaces 34 and 36 allow for some axial (i.e. outward) movement of the flange 28 but limit the extent to which this can occur. This distance can be selectively adjusted to meet the requirements of the particular expansion joint and application.

In order to limit the movement of the flanges 27 and 28 toward each other, and therefore limit the compression of the expansion joint, a pair of nuts, similar to the nuts 32 and 33, can be selectively placed on the inner sides of the respective flanges 27 and 28. Another approach is to place a pair of sleeves 37 and 38 over the respective tie rods pins 29 and 31 as shown, with the lengths of the sleeves 37 and 38 being generally shorter than the distance between the two flanges 27 and 28. In this way, the flanges 27 and 28 are free to move inwardly, toward each other, to thereby allow for contraction of the body member 26 but this movement is limited when the inner surfaces of the flanges 27 and 28 begin to impinge on the ends of the sleeves 37 and 38.

A variation of the FIG. 2 approach is to provide for two or more radially outwardly extending gussets to be attached to the flanges 27 and 28 and, rather than extending the pins 29 and 31 through the flanges 27 and 28, extending the pins 29 and 31 through openings in the gussets.

Use of tie rod pins 29 and 31 as discussed hereinabove is problematic in some situations. For example, since the tie rod pins are installed on the assembly at the factory and shipped to the site for installation, even though the pins 29 and 31 and their associated nuts 32 and 33 are not adjusted to their final position, the assembly is very rigid in nature and presents difficulties in the process of aligning the expansion joint and securing it in its installed position between two pipe sections. Further, there is often very little space in which to work such that final adjustments and the selective positioning of the nuts 32 and 33 can be difficult.

Referring now to FIG. 3, a pair of axially spaced flanges 39 and 41 are shown with radially outwardly extending gussets 42 and 43 attached thereto. The gussets 42 and 43 are secured by way of a plurality of bolts 44 passing through openings 46. For illustrative purposes, the gusset 42 is shown to be installed on the inner side of the flange 39, and the gusset 43 is shown to be attached on the outer side of the flange 41. Although this is a possible arrangement, a more likely installation would be for the two gussets to be on the inner sides of their respective flanges or on the outer sides thereof.

Near the radially outer end of the gusset 42 is a pair of spaced holes 47 and 48. Similarly, near the radially outer end of the gusset 43 is a pair of spaced holes 49 and 51. These holes are used for attachment purposes.

Rather than the use of tie rod pins, the gussets 42 and 43 are interconnected by a cable 52 having two strands 53 and 54. The first strand 53 passes into holes 48 and 51, wraps around the outer surfaces of the respective gussets 42 and 43, and then comes back through holes 47 and 49. The second strand 54 results from the two ends being fastened together by one or more fastening devices 56 such as a crimping device. The result is a double stranded cable which is easy to install either at the factory or on the installation site and which functions to limit the axial separation of the two flanges 39 and 41, and thus the expansion of the expansion joint.

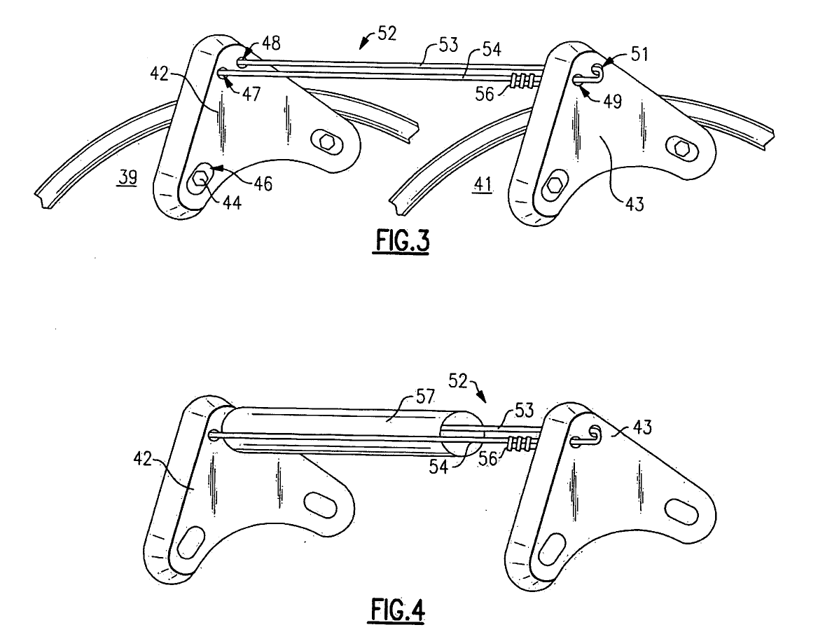

As will be understood, the FIG. 3 embodiment does not provide any protection against over compression of the system. Accordingly, the FIG. 4 embodiment is substantially the same except that a sleeve 57 is disposed over the strand 53 such that in a non-compressed condition, there is a space between the one end of the sleeve 57 and the inner side of the gusset 43. When compression occurs, the two gussets 42 and 43 tend to be moved toward each other, but that movement is limited when the ends of the sleeve 57 become engaged with the inner sides of the gussets 42 and 43. Such an arrangement allows for the strand 54 to be freely accessible for purposes of joining the two ends of the cable 52 for the purpose of installing the crimping device 56.

While the present invention has been particularly shown and described with reference to preferred and modified embodiments as illustrated by the drawings, it will be understood by one skilled in the art that various changes in detail may be made thereto without departing from the spirit and scope of the invention as defined by the claims.

We claim:

1. An expansion joint assembly comprising:
a generally cylindrical flexible body for conducting the flow of fluid therethrough and adapted to be fluidly connected to a pipe structure on either end thereof;
a pair of axially spaced flanges secured at opposite ends of said flexible body so as to be axially moved toward or away from each other as said flexible body is axially contracted or expanded, respectively; and
at least two circumferentially spaced cables being attached to, and extending between, said pair of flanges or radial extensions thereof, each of said cables being unitary in form but having two parallel strands, and with the two ends of the cable being interconnected.

2. An expansion joint assembly as set forth in claim 1 wherein said flexible body comprises a bellows with a plurality of corrugations.

3. An expansion joint assembly as set forth in claim 2 wherein said flexible body is formed of a metal material.

4. An expansion joint assembly as set forth in claim 2 wherein said flexible body is formed of a Teflon material.

5. An expansion joint assembly as set forth in claim 1 wherein said flexible body is formed of an elastomeric material.

6. An expansion joint assembly as set forth in claim 1 wherein said flange radial extensions comprise gussets which are attached to a radially outward portion of said flanges and extend further radially outwardly.

7. An expansion joint assembly as set forth in claim 1 wherein said cables are attached to said flanges by a pair of spaced holes, with the cable passing through one hole, around an outer surface of said flange or its radial extension thereof, and back through the other spaced hole.

8. An expansion joint assembly as set forth in claim 1 wherein said cable ends are interconnected by a crimping device.

9. An expansion joint assembly as set forth in claim 1 and including a rigid sleeve disposed concentrically around one strand and having an axial length such that when said flexible body is compressed to a predetermined degree, the ends of the sleeve will engage the respective inner sides of said flanges or radial extension thereof so as to limit further contraction.

10. An expansion joint of the type having a fluid conducting flexible body member disposed between a pair of axially spaced flanges said flexible body being adapted to axial expand or contract with changes in operational conditions, comprising:
a pair of circumferentially spaced cables being attached to and extending between said pair of flanges or radial extensions thereof, each of said cables being a unitary member with two parallel strands and with the two ends of the cable being interconnected.

11. An expansion joint assembly as set forth in claim 10 and including a rigid sleeve disposed concentrically around one strand and having an axial length such that when said flexible body is contracted to a predetermined degree, the ends of the sleeve will engage the respective inner sides of said flanges on radial extension thereof so as to limit further contraction.

12. An expansion joint assembly comprising:
a generally cylindrical flexible body for conducting the flow of fluid therethrough and adapted to be fluidly connected to a pipe structure on either end thereof;
a pair of axially spaced flanges secured at opposite ends of said flexible body so as to be axially movable toward or away from each other as said flexible body is axially contracted or expanded, respectively; and
at least two circumferentially spaced cables being attached to, and extending between, said pair of flanges or radial extensions thereof, each of said cables being unitary in form but having two parallel strands, and with the two ends of the cable being interconnected.

13. An expansion joint assembly as set forth in claim 12 wherein said flexible body has a bellows with a plurality of corrugation.

14. An expansion joint assembly as set forth in claim 13 wherein said flexible body is formed of a metal material.

15. An expansion joint assembly as set forth in claim 13 wherein said flexible body is formed of a Teflon material.

16. An expansion joint assembly as set forth in claim 12 wherein said flexible body is formed of an elastomeric material.

17. An expansion joint assembly as set forth in claim 12 wherein said flange radial extensions comprise gussets which are attached to a radially outward portion of said flanges and extend further radially outwardly.

18. An expansion joint assembly as set forth in claim 12 wherein said cables are attached to said flanges by a pair of spaced holes, with the cable passing through one hole, around an outer surface of said flange or its radial extension thereof, and back through the other spaced hole thereof.

19. An expansion joint assembly as set forth in claim 12 and including a rigid sleeve disposed concentrically around one strand and having an axial length such that when said flexible body is compressed to a predetermined degree, the ends of the sleeve will engage the respective inner sides of said flanges on radial extension thereof so as to limit further contraction.

20. A method of limiting the contraction and expansion of an expansion joint of the type having a fluid conducting flexible body member disposed between a pair of axial spaced flanges, with said flexible body being adapted to axial expand or contract with changes in operational conditions, comprising the steps of:
extending at least two circumferentially spaced cables between and connecting to each of said spaced flanges or to radial extension thereof, with each of said cables being unitary in form but having two parallel strands; and
connecting the two ends of the cable.

21. A method as set forth in claim 20 wherein said flexible body has a bellows with a plurality of corrugation.

22. A method as set forth in claim 21 wherein said flexible body is formed of a metal material.

23. A method as set forth in claim 21 wherein said flexible body is formed of a Teflon material.

24. A method as set forth in claim 20 wherein said flexible body is formed of an elastomeric material.

25. A method as set forth in claim 20 wherein said flange radial extensions comprise gussets which are attached to a radially outward portion of said flanges and extend further radially outwardly.

26. A method as set forth in claim 20 wherein said cables are attached to said flanges by a pair of spaced holes, with the cable passing through one hole, around an outer surface of said flange or its radial extension thereof, and back through the other spaced hole thereof.

27. A method as set forth in claim 20 wherein said cable ends are interconnected by a crimping device.

28. A method as set forth in claim 20 concentrically and including the further step of mounting a sleeve over one of said strands, said sleeve having an axial length such that an expansion joint assembly as set forth in claim 1 and including a rigid sleeve disposed concentrically around one strand and having an axial length such that when said flexible body is compressed to a predetermined degree, the ends of the sleeve will engage the respective inner sides of said flanges on radial extension thereof so as to limit further contraction.
